(19) United States
(12) Patent Application Publication
(10) Pub. No.: US 2025/0342334 A1
(43) Pub. Date: Nov. 6, 2025

(54) SECURE ELEMENT WITH HEAP MEMORY

(71) Applicant: GIESECKE+DEVRIENT EPAYMENTS GMBH, Munchen (DE)

(72) Inventors: Thomas STOCKER, Munchen (DE); Ingeborg FLADÉE, Munchen (DE); Jorn TREGER, Rosenheim (DE)

(21) Appl. No.: 18/864,653

(22) PCT Filed: May 9, 2023
(86) PCT No.: PCT/EP2023/025218

§ 371 Date: Nov. 11, 2024

(30) Foreign Application Priority Data
May 12, 2022 (DE) 10 2022 001 682.6

(51) Int. Cl. G06K 19/073

(52) U.S. Cl. CPC G06K 19/07309

(57) ABSTRACT

A secure element includes: a virtual machine; a non-volatile heap memory unit (NVM heap) which is arranged in a non-volatile memory unit (NVM); and a volatile working memory unit (RAM) which is designed to non-persistently store data. The secure element is wherein: a volatile heap memory unit (RAM heap) which is arranged in the RAM and contains at least one volatile heap memory segment. The session is temporally limited by a beginning and an end of the session such that an object on the volatile heap memory unit segment has a lifespan which is temporally limited in a manner corresponding to the temporally limited duration of the session. A memory managing method in a secure element, has the steps of installing an object, which includes an object header and object data, on such a volatile heap storage memory segment.

### FIELD OF THE INVENTION

The invention relates to a secure element, in particular a Java-Card-based microprocessor device. Java Card forms a reduced version of the Java programming language which takes into account specifically the restrictions of secure elements such as smartcards or other forms or packages of tamper-proof security chips. Examples of secure elements are payment transaction cards and virtualized payment transaction cards provided in software. Further examples of secure elements are subscriber identity modules—SIMs—having any form factor, in particular SIM cards or UICCs, solderable eUICCs, iUICCs integrated into a chipset. A Java-Card-based microprocessor device in the form of a chip card is widely referred to as a Java Card, as the most original form factor of a secure element of this type.

### PRIOR ART

Document [1] JCCRE_3-1_February-2021-Java Card™ Platform Runtime Environment Specification, Classic Edition, Version 3.1, February 2021, is one of the fundamental specifications for Java Card technology. Document [1] deals with secure elements, such as, for example, smartcards and other tamper-proof security chips (Preface).

Document [1] JCCRE_3-1 discloses that Java Card objects are generally created on a persistent heap memory and are retained when the Java Card is reset (see Chapter 2—Lifetime of the Java Card Virtual Machine, and Chapter 5—Memory Model). However, document [1] JCCRE_3-1, Chapter 5, also discloses two types of non-persistent objects, i.e. in Chapter 5.1 transient objects, and in Chapter 5.2 temporary objects, in particular array views (Chapter 5.3) as a special case of temporary objects.

As explained in Chapter 5.1, only the contents of the data fields of the transient objects are of a transient nature, since they are stored in a volatile RAM memory, and not e.g. in a non-volatile EEPROM memory. The contents of the data fields of a transient object are deleted when an event occurs, which is either a RESET of the secure element, or a DESELECT of a selected applet containing the transient object. Document [1] JCCRE_3-1 cites two types of transient objects, i.e. CLEAR_ON_RESET transient objects and CLEAR_ON_DESELECT transient objects.

Conversely, the headers of transient objects are stored on the heap memory of the secure element which is provided in the non-volatile memory NVM (e.g. EEPROM).

If a transient object is intended to be completely removed, it does not suffice to trigger the necessary event, such as, for example, deselecting the applet containing the object or resetting the secure element. The header in the non-volatile heap memory remains even after a deselect or reset and must be actively removed if required, for example by means of a garbage collection mechanism.

It would be desirable for objects which are only required temporarily, for example until the next reset of the secure element, or until the next deselect of the applet containing the object, to have a memory architecture which enables efficient management, in particular creation and/or deletion, of the objects.

The temporary objects according to Chapters 5.2 and 5.3 are transient objects which can only be referenced by the current program execution flow, and can only be referenced by the execution stack as local variables. Consequently, only a very limited number of objects can be created as temporary objects, i.e. (i) some special entry point objects, (ii) global arrays, and (iii) array views.

Document U.S. Pat. No. 7,702,872B2 from the prior art discloses a secure element comprising a virtual machine which is implemented in a non-volatile system memory, and also a non-volatile application memory and a volatile working memory, and furthermore a variable memory area for global variables, which is provided in a volatile working memory.

### SUMMARY OF THE INVENTION

The invention is based on the object of providing a secure element having a memory architecture which enables efficient management, in particular creation and/or deletion, of objects which are only required temporarily.

The secure element comprises:-a virtual machine;-a non-volatile heap memory which is arranged in a non-volatile memory and is configured for the persistent storage of objects; and-a volatile working memory which is configured for non-persistent storage of data. The secure element is characterized by: a volatile heap memory which is arranged in the volatile working memory and contains at least one volatile heap memory segment which is configured to keep objects stored at most only for a time-limited duration of a session of the volatile heap memory segment. The session is time-limited here by a beginning and an end of the session. An object on the volatile heap memory segment has a lifetime that is time-limited according to the time-limited duration of the session.

Object headers are stored in the heap memory and therefore conventionally in the non-volatile heap memory. The volatile heap memory according to the invention which is arranged in the volatile working memory enables storage not only of data fields of objects, but also of object headers of objects, in the volatile memory. As a result, not only the data fields but also the object headers of an object are created in volatile form. More precisely, the lifetime of the complete object, comprising object data fields and object headers, can be created with a lifetime that is time-limited to the duration of a session. Even more precisely, the lifetime of a complete object can be limited according to the session characteristics of the volatile heap memory segments on which the object header is created. An explicit deletion of object headers of volatile objects created in this way is no longer required.

A secure element is therefore created having an architecture which enables efficient management, in particular creation and/or deletion, of objects which are only required temporarily.

An object in the context of the invention preferably comprises an object header and one or more object data fields. The volatile heap memory or the volatile heap memory segment of the volatile memory is then configured to keep both the object header and the object data fields of an object stored. As a result, the limited duration of a session of the volatile heap memory segment of the volatile heap memory affects both the object header and the object data fields of an object. As a result, the complete object has a uniform limited lifetime which is time-limited to the duration of the session.

The volatile heap memory can be totally or partially configured as:
clear-on-reset heap, wherein the end of the session is effected by resetting the secure element; and/or
clear-on-deselect heap, wherein the end of the session is effected by deselecting an application of which one or more objects are stored in the volatile heap memory (RAM heap); and/or
clear-on-session-deactivation heap, wherein the end of the session is effected by a command directed at the secure element to end a currently running session.

The beginning of the session can be effected by one of the following:
starting the secure element; and/or
selecting an application of which one or more objects are stored on the volatile heap memory (RAM heap);
activating the or a volatile heap memory segment, in particular activating by means of an application, or alternatively by means of the operating system or otherwise.

The beginning and end of a session can be effected by similar events, such as:—beginning by starting, and ending by resetting (or shutting down) the secure element;—beginning by selecting (Select), and ending by deselecting an application;—beginning by activating, and ending by deactivating a volatile heap memory segment.

Alternatively, the beginning and end of a session are effected by events of different types, for example:—beginning by selecting an application, and ending by resetting (or shutting down) the secure element.

The volatile heap memory can be segmented into at least two, or more, volatile heap memory segments, wherein at least some of the volatile heap memory segments have different time-limited durations of a session of the volatile heap memory segment and corresponding different lifetimes of objects on the respective volatile heap memory segment. This embodiment of the invention enables a targeted creation of complete objects with differently designed lifetimes by creating the objects on volatile heap memory segments having different time durations of the session. A first object, for example, is created on a first volatile heap memory segment which is designed as a clear-on-reset heap so that the first object is deleted only when the secure element is reset, according to the invention comprising deleting data fields and headers of the first object. A second object is created on the second volatile heap memory segment which is designed as a clear-on-deselect heap so that the second object is deleted as soon as the application containing the object application is deselected, according to the invention comprising deleting data fields and headers of the second object. However, the second object is also deleted if the secure element is reset without the application previously being deselected, either through targeted reset or through accidental interruption and restoration of the voltage supply.

At least some of the volatile heap memory segments, or each volatile heap memory segment, can be designed so that references to an object stored in the respective volatile heap memory segment can be stored only in the volatile heap memory segment in which the object itself is stored. This ensures that no dangling references remain after an object has been deleted according to the invention through session expiry, i.e. after the session of the heap memory segment storing the objects has been ended (has expired). Conversely, if the reference was stored on a different heap memory segment having a longer session duration than the heap memory segment on which the object referenced by the reference is located, the reference would remain alive longer than the object and a dangling reference would thus be left behind.

The secure element can be designed as a Java-Card-based microprocessor device. In this case, the objects are Java Card objects, and heap memories are Java Card heap memories, but, in the case of the volatile heap memory, they are created in the volatile working memory.

The secure element can be designed as: payment transaction card, virtual payment transaction card, mobile radio subscriber identity module (SIM; e.g. eUICC, UICC, SIM card, etc.), identity document module (pass, ID card), health card.

Each volatile heap memory segment can have a segment size, wherein, for at least some or all of the volatile heap memory segments, the segment size can be modified during the lifetime of the heap memory segment. This embodiment of a volatile heap memory segment allows flexible adjustment of the segment size according to the current memory requirement, thereby, on one hand, taking up as little storage space as possible and, on the other hand, providing sufficient memory space. An object can have an object size, wherein the object size comprises the data fields and the headers. The segment size of the volatile heap memory segment can be created as equal to the object size. If the object size is modified, for example by adding or removing data fields, the segment size of the volatile heap memory segment is similarly modified according to the modified object size.

The secure element can further comprise an object which is stored on the volatile heap memory and comprises an object header and object data fields which are stored in the volatile heap memory.

The secure element can further comprise a transient object which comprises an object header which is stored in the non-volatile heap memory and which comprises one or more data fields which are stored in the volatile heap memory so that, in particular, the transient object serves or can serve as a root object for objects stored in the volatile heap memory.

Unlike the objects created according to the invention completely on the volatile heap memory, in which case, when the object is deleted, the header of the object is also deleted and said objects could therefore be referred to as volatile objects, in the case of a transient object, the header remains stored when the object is deleted, since the header has been stored in the non-volatile conventional heap memory.

A method according to the invention for memory management in a secure element comprising a virtual machine, a non-volatile memory and a volatile working memory, comprises creating an object comprising an object header and object data on a heap memory of the secure element. The method is characterized in that the object is created on a volatile heap memory segment:—which is contained in a heap memory arranged in the volatile working memory; and—on which the object is kept stored at most only for the time-limited duration of a session of the volatile heap memory segment, wherein the session is time-limited by a beginning and an end of the session so that the object on the volatile heap memory segment has a lifetime that is time-limited according to the time-limited duration of the session.

The method can be applied such that at least two, or more, objects are created on at least two or more volatile heap memory segments of the volatile heap memory, wherein at least some of the volatile heap memory segments have different durations of the session of the volatile heap memory segment so that objects having differently limited lifetimes are correspondingly created on the respective volatile heap memory segment. Furthermore, heap memory segments can also be created with a variable segment size, as already described above.

According to embodiments of the invention, the object can be created on a volatile heap memory segment in one of the following ways:
(a) direct creation on the volatile heap memory segment—a volatile object is thereby created directly, whereby the object headers and data fields for object data of said object are likewise saved to the non-volatile heap memory;
(b) creation of the object on a memory other than the volatile heap memory segment, in particular on the non-volatile heap memory, and subsequent copying of the object into the volatile heap memory segment—an initially non-volatile or transient object transforming into a volatile object is thereby copied.

The created object can be created by a generating object, wherein the generating object is designed as one of the following:
(a) as a transient object comprising an object header in the non-volatile heap memory and one or more data fields for object data in the volatile memory, wherein the created object is created in one or more of the data fields of the generating object—since the generated object is located completely in the area of the object data of the creating object, the generated object is automatically a volatile object in which the object header and the object data are volatile;
(b) as a volatile object comprising an object header and one or more data fields in the volatile memory, wherein the created object is created in one or more of the data fields of the generating object—an object created by a volatile object is automatically again a volatile object.

Since a created object is created by a transient or volatile object, the “volatile” class can be implicitly assigned to the created object, which is not explicitly possible in Java Card, since Java Card does not provide for the transfer of class types as parameters.

### BRIEF DESCRIPTION OF THE DRAWINGS

The invention is explained in detail below on the basis of exemplary embodiments and with reference to the drawing, in which:

FIG. 1 shows a schematic view of a heap memory arrangement of a secure element, according to one embodiment of the invention.

### DETAILED DESCRIPTION OF EXEMPLARY EMBODIMENTS

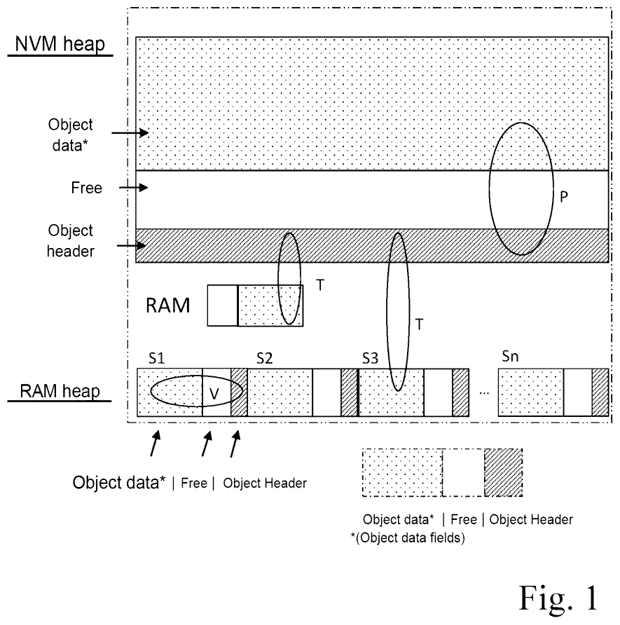

FIG. 1 shows a schematic view of a heap memory arrangement of a secure element, according to one embodiment of the invention. The following pattern coding is used in FIG. 1. Free memory areas are shown as white. Memory areas occupied by object data are shown as dotted. Memory areas occupied by object headers are shown as striped. The heap memory arrangement of the secure element comprises a non-volatile heap memory, NVM heap, which can also be designed as a non-volatile heap memory known from the prior art, and a volatile working memory RAM. The non-volatile heap memory, NVM heap, is configured to store persistent objects P, in the case of which both the object header H and the object data D are stored in object data fields in the non-volatile heap memory, NVM heap. A persistent object P in the non-volatile heap memory, NVM heap, is indicated schematically by an oval P. The non-volatile heap memory, NVM heap, interacting with the working memory, RAM, can further store transient data, in the case of which the object header is stored in the non-volatile heap memory, NVM heap, and the object data are stored in the object data fields in the volatile working memory RAM. Two ovals T indicate schematically two transient objects T, in the case of which the object header is stored in the non-volatile heap memory, NVM heap, and the object data or object data fields are stored in a largely random available area of the volatile working memory RAM.

According to the invention, the secure element further has a volatile heap memory, RAM heap, which is arranged in the volatile working memory RAM and is configured to keep entire objects stored, and not only parts of objects, such as, for example, only the object data fields with the object data or only the object headers. The volatile heap memory, RAM heap, shown in FIG. 1 is segmented into a plurality of segments S1, S2, S3, . . . Sn. The term “volatile object” is introduced in the context of the invention to designate an object in which both the object data and the object header are stored in the volatile heap memory, RAM heap, according to the invention. An oval V indicates a volatile object of which the object data fields with the object data, and also the object headers are both stored in the volatile heap memory, RAM heap, more precisely in a heap memory segment S1.

In order to demonstrate that the object data of transient objects do not have to be stored in the RAM heap according to the invention, a small section of the volatile working memory RAM is shown schematically in order to illustrate the one transient object T, with a free area (white), and an area occupied by object data (dotted). A second transient object has an object header in the non-volatile heap memory, NVM heap, and object data (object data fields) in a heap memory segment S3 of the volatile heap memory, RAM heap.

### PRIOR ART

[1] [JCCRE_3-1] JCCRE_3-1_February-2021-Java Card™ Platform Runtime Environment Specification, Classic Edition, Version 3.1, February 2021

1.-15. (canceled)

16. A secure element comprising:
a virtual machine;
a non-volatile heap memory which is arranged in a non-volatile memory and is configured for the persistent storage of objects; and
a volatile working memory which is configured for non-persistent storage of data;
wherein a volatile heap memory which is arranged in the volatile working memory and contains at least one volatile heap memory segment which is configured to keep objects stored at most only for a time-limited duration of a session of the volatile heap memory segment,
wherein the session is time-limited by a beginning and an end of the session so that an object on the volatile heap memory segment has a lifetime that is time-limited according to the time-limited duration of the session.

17. The secure element according to claim 16, wherein an object comprises an object header and one or more object data fields, and
wherein the volatile heap memory is configured to keep both the object header and the object data fields of an object stored.

18. The secure element according to claim 17, wherein the volatile heap memory is totally or partially configured as:
clear-on-reset heap, wherein the end of the session is effected by resetting the secure element; and/or
clear-on-deselect heap, wherein the end of the session is effected by deselecting an application of which one or more objects are stored in the volatile heap memory; and/or
clear-on-session-deactivation heap, wherein the end of the session is effected by a command directed at the secure element to end a currently running session.

19. The secure element according to claim 16, wherein the beginning of the session is effected by one of the following actions:
starting the secure element; and/or
selecting an application of which one or more objects are stored on the volatile heap memory;
activating the or a volatile heap memory segment,
activating the or a volatile heap memory segment by means of an application, by means of the operating system or by means of a different instance in or under the control of the secure element.

20. The secure element according to claim 16, wherein the volatile heap memory is segmented into at least two, or more, volatile heap memory segments,
wherein at least some of the volatile heap memory segments have different time-limited durations of a session of the volatile heap memory segment and corresponding different lifetimes of objects on the respective volatile heap memory segment.

21. The secure element according to claim 16, wherein at least some of the volatile heap memory segments, or each volatile heap memory segment, is designed so that references to an object stored in the respective volatile heap memory segment can be stored only in the volatile heap memory segment in which the object itself is stored.

22. The secure element according to claim 16, designed as a Java-card-based microprocessor device.

23. The secure element according to claim 16, designed as a payment transaction card or virtual payment transaction card, or as a subscriber identity module or as an identity document module or as a health card.

24. The secure element according to claim 16, wherein each volatile heap memory segment has a segment size, and
wherein, for at least some or all of the volatile heap memory segments, the segment size can be modified during the lifetime of the heap memory segment.

25. The secure element according to claim 16, further comprising an object which is stored on the volatile heap memory and comprises an object header and object data fields which are stored in the volatile heap memory.

26. The secure element according to claim 25, further comprising a transient object which comprises an object header which is stored in the non-volatile heap memory and which comprises one or more data fields which are stored in the volatile heap memory so that the transient object serves as a root object for objects stored in the volatile heap memory.

27. A method for memory management in a secure element comprising a virtual machine, a non-volatile memory and a volatile working memory, the method comprising:
creating, on a heap memory of the secure element, an object, referred to as a created object, comprising an object header and object data,
wherein the object is created on a volatile heap memory segment,
which is contained in a volatile heap memory arranged in the volatile working memory, and
on which the object is kept stored at most only for the time-limited duration of a session of the volatile heap memory segment,
wherein the session is time-limited by a beginning and an end of the session so that an object on the volatile heap memory segment has a lifetime that is time-limited according to the time-limited duration of the session.

28. The method according to claim 27, wherein at least two, or more, objects are created on at least two or more volatile heap memory segments of the volatile heap memory,
wherein at least some of the volatile heap memory segments have different durations of the session of the volatile heap memory segment so that objects having differently limited lifetimes are correspondingly created on the respective volatile heap memory segment.

29. The method according to claim 27, wherein the object is created on a volatile heap memory segment in one of the following ways:
(a) direct creation on the volatile heap memory segment;
(b) creation of the object on a memory other than the volatile heap memory segment, on the non-volatile heap memory, and subsequent copying of the object into the volatile heap memory segment.

30. The method according to claim 27, wherein the created object is created by a generating object,
wherein the generating object is designed according to one of the following:
(a) as a transient object comprising an object header in the non-volatile heap memory and one or more data fields for object data in the volatile memory, wherein the created object is created in one or more of the data fields of the generating object;
(b) as a volatile object comprising an object header and one or more data fields in the volatile memory, wherein the created object is created in one or more of the data fields of the generating object.
